(19) United States
(12) Patent Application Publication
(10) Pub. No.: US 2025/0271546 A1
(43) Pub. Date: Aug. 28, 2025

(54) ELECTRONIC WARFARE SYSTEM HAVING OPTIMIZED MULTIPLE SCAN SCHEDULES

(71) Applicant: BAE Systems Information and Electronic Systems Integration Inc., Nashua, NH (US)

(72) Inventors: James R. Jolly, Merrimack, NH (US); James Ducas, Manchester, NH (US)

(73) Assignee: BAE Systems Information and Electronic Systems Integration Inc., Nashua, NH (US)

(21) Appl. No.: 18/585,997

(22) Filed: Feb. 23, 2024

(51) Int. Cl. G01S 7/38

(52) U.S. Cl. CPC G01S 7/38

(57) ABSTRACT

An electronic warfare (EW) system that is to be installed on a platform has a plurality receivers that are part of the EW system. A first receiver may be an electronic countermeasure (ECM) to discriminate characteristics of an incoming first signal from a first emitter. The first receiver operates at a first bandwidth on a first scan schedule. A second receiver may be a radar warning (RW) component to discriminate characteristics of an incoming second signal from a second emitter. The second receiver operates at a second bandwidth on a second scan schedule. The EW system has a processor that executes instructions to interleave the first scan schedule and second scan schedule. Interleaving the first scan schedule and the second scan schedule may provide the EW system as an integrated EW system with predictable performance that is optimized for environmental load and receiver allocation.

### STATEMENT OF GOVERNMENT INTEREST

This invention was made with government support under Subcontract Number 1170366 awarded by the U.S. Air Force. The government has certain rights in the invention.

### TECHNICAL FIELD

The present disclosure relates generally to the field of sensors and transmitters. More particularly, in one example, the present disclosure relates to an asset management system. Specifically, in another example, the present disclosure relates to an electronic warfare asset management system and process utilizing mission data files and adaptive scan schedules.

### BACKGROUND ART

Electronic warfare (EW) is one of many facets of modern military operations. Specifically, electronic warfare is the observation and use of the electromagnetic spectrum, including actions to detect, evade, attack, or impede enemy vehicles or installations that likewise broadcast or operate within the electromagnetic spectrum. The general purpose of EW is to utilize the electromagnetic spectrum to obtain an advantage for operations in neutral or contested environments. EW may be applied from multiple platforms ranging across all frequencies of the electromagnetic spectrum and may be utilized in air, sea, land, and/or space operations by both manned and unmanned systems.

One of the most common military uses of EW is through the use, operation, and manipulation of radar signals. Radar signals may be actively used to locate and track a target or to guide munitions to a target. Radar may also be passively used to locate and track by “listening” or monitoring for emitted signals originating from enemy sources. Further, stealth technologies, jamming emissions, and other defensive measure may be employed to thwart the use of radar in such location, tracking, and/or targeting efforts. Radar utilizes radio waves to determine the range, angle and/or velocity of objects by producing electromagnetic waves and measuring the reflection and return of those waves as they bounce off an object and return to a receiver. Thus, modern military applications of radar tend to include threat detection, threat avoidance, and threat engagement, along with tracking of enemy movements.

EW also includes the use of the electromagnetic spectrum to locate enemy positions through the active monitoring and detecting of emitters and the electromagnetic signals produced therefrom. While this includes radar and radio waves, it may also include other bands of the electromagnetic spectrum, including visible light and infrared light.

As it further relates to military operations, EW is an important aspect of both offensive and defensive operations in that these technologies tend to integrate radar warning systems with geolocation and direction finding processes, situational awareness, and/or self-protection (countermeasure) systems. Further, EW is utilized to detect and defeat advanced threats in operational environments, including environments that are highly contested with dense signal activity. EW systems may further enable deeper penetration, protection against modern integrated defenses, and enhance mission effectiveness.

As military technology advances, particularly those technologies related to EW systems, new emitters have come online that are capable of operation in multiple frequencies of the electromagnetic spectrum and across multiple channels. These advanced emitters are capable of both broadcasting and receiving in short, non-continuous bursts, and are considered to be very agile systems that may both move in physical location as well as jump through multiple parametric spaces such as frequency and dynamic ranges to evade detection while maintaining effective detection capabilities of their own. Thus, most modern emitters now have a low probability of intercept (LPI) properties, forcing EW systems to adapt to account for the agility and complexity of these modern threats.

### SUMMARY OF THE INVENTION

The present disclosure addresses these and other issues by providing an electronic warfare (EW) system that overcomes the limitations that current receivers/emitters possess, such as finite bandwidth, polarization, and dynamic range.

In one aspect, an exemplary embodiment of the present disclosure may provide an EW system for installation on a platform, the EW system comprising: a first receiver to measure discriminating characteristics of an incoming first signal, the characteristics indicative of a source direction or geolocation of a first emitter producing the first signal, wherein the first receiver is adapted to be installed on the platform; a first bandwidth at which the first receiver operates; a second receiver to discriminate characteristics of an incoming second signal, the characteristics indicative of a source direction or geolocation of a second emitter producing the second signal, wherein the second receiver is adapted to be installed on the platform and spaced from the first receiver; a second bandwidth at which the second receiver operates, wherein the second bandwidth it different than the first bandwidth; wherein one or both of the first emitter and the second emitter is a point of interest (POI); a processor that executes instructions for managed extensions to implement an adaptive scan schedule to report a correct and unambiguous identification (CUID) of the POI, wherein the managed extensions include extensions for direction finding (DF), geolocation, polarization, gain, and pulse repetition interval (PRI) measurements for at least one of the incoming first and second signals. This exemplary embodiment or another exemplary embodiment may further provide that the instructions for the managed extensions are only executed by the processor when either the first emitter or the second emitter is present which is adapted to minimize managed extensions effects on POI determination performance. This exemplary embodiment or another exemplary embodiment may further provide that the instructions for the managed extensions are executed by the processor for only an amount of time necessary to collect data required for DF, geolocation, polarization, gain, and PRI measurements. This exemplary embodiment or another exemplary embodiment may further provide that the amount of time necessary to collect data required for DF, geolocation, polarization, gain, and PRI measurements is based on a programmed minimum collection time, a programmed maximum collection time, and/or a pulse collection count. This exemplary embodiment or another exemplary embodiment may further provide that a dwell time for the first receiver and a dwell time for the second receiver extends until the pulse collection count is satisfied not to exceed the programmed maximum collection time. This exemplary embodiment or another exemplary embodiment may further provide that the pulse collection count is dynamic. This exemplary embodiment or another exemplary embodiment may further include an expansion factor for the adaptive scan schedule, wherein the expansion factor accounts for the managed extensions to generate the adaptive scan schedule that maintains POI determination performance as dwell times are dynamically expanded. This exemplary embodiment or another exemplary embodiment may further provide that at least one of the first emitter and the second emitter is a low probability of intercept (LPI) emitter. There may be instructions for the adaptive scan schedule to adaptively adjust spectral detection bands of at least one of the first receiver and the second receiver in response to frequency hopping performed by the LPI emitter. This exemplary embodiment or another exemplary embodiment may further provide that the first receiver is an electronic countermeasure (ECM) component and the second receiver a radar warning (RW) component. This exemplary embodiment or another exemplary embodiment may further include a feedback mechanism in operative communication with the processor to adjust the adaptive scan schedule for one of the first receiver and the second receiver in response to feedback from the feedback mechanism.

In another aspect, an exemplary embodiment of the present disclosure may provide an EW system for installation on a platform, the EW system comprising: a first receiver, wherein the first receiver is an ECM component to generate a jamming signal, wherein the first receiver is adapted to be installed on the platform; a first bandwidth at which the first receiver operates; a second receiver, wherein the second receiver is a RW component to discriminate characteristics of an incoming first signal from a first emitter, wherein the second receiver is adapted to be installed on the platform and spaced from the first receiver; and a processor that executes instructions to integrate a blanking technique for the RW component and the ECM component to interoperate to collect data at the same time on each respective receiver. This exemplary embodiment or another exemplary embodiment may further provide that the instructions control the ECM component to generate the jamming signal that jams the first signal and monitors the first signal via the RW component to eliminate simultaneously scanning by the ECM component and the RW component. This exemplary embodiment or another exemplary embodiment may further provide that the blanking technique includes look-through sequences, and the instructions control and integrate the look-through sequences to enable the RW component and ECM component to satisfy a collection need and minimize a total ECM component blanking timeline. This minimization of ECM component blanking can be achieved by integrating the ECM and RW collection times across multiple receivers. This exemplary embodiment or another exemplary embodiment may further provide that the instructions control the RW component to maintain a track on the first emitter without performing a look-through sequence. This exemplary embodiment or another exemplary embodiment may further include a jamming signal generated by the ECM component. This exemplary embodiment or another exemplary embodiment may further provide that the blanking technique includes an adaptive filter. This exemplary embodiment or another exemplary embodiment may further provide that the blanking technique includes time division multiplexing.

In yet another aspect, an exemplary embodiment of the present disclosure may provide an EW system for installation on a platform, the EW system comprising: a first receiver, wherein the first receiver is an ECM to discriminate characteristics of an incoming first signal from a first emitter, wherein the first receiver is adapted to be installed on the platform, and wherein the first receiver operates at a first bandwidth on a first scan schedule; a second receiver, wherein the second receiver is a RW component to discriminate characteristics of an incoming second signal from a second emitter, wherein the second receiver is adapted to be installed on the platform and spaced from the first receiver, and wherein the second receiver operates at a second bandwidth on a second scan schedule; and a processor that executes instructions to interleave the first scan schedule and second scan schedule, wherein interleaving the first scan schedule and the second scan schedule is adapted to provide the EW system as an integrated EW system with predictable performance that is optimized for environmental load and receiver allocation. This exemplary embodiment or another exemplary embodiment may further provide that the instructions control assets of the first receiver and the second receiver to be allocated in real time. This exemplary embodiment or another exemplary embodiment may further provide that the instructions control assets of the first receiver and the second receiver to be allocated in real time based on integration of all available asset at any time during operation of the EW system. This exemplary embodiment or another exemplary embodiment may further provide that the instructions integrate assets of the first receiver and the second receiver to be shared between the first receiver and the second receiver. This exemplary embodiment or another exemplary embodiment may further provide that the instructions integrate assets of the first receiver and the second receiver to be shared amongst all receivers in the EW system. This exemplary embodiment or another exemplary embodiment may further provide that wherein the instructions dynamically allocate assets of the first receiver and the second receiver. This exemplary embodiment or another exemplary embodiment may further include a first performance metric of the first receiver; a second performance metric of the second receiver, wherein the first performance metric and the second performance metric are different. This exemplary embodiment or another exemplary embodiment may further include a joint mission data file generator (MDFG) associated with both the first receiver and the second receiver, wherein the joint MDFG optimizes the first scan schedule and second scan schedule. This exemplary embodiment or another exemplary embodiment may further provide that the joint MDFG is in operative communication with a user-specific scan schedule optimization algorithm that optimizes the first scan schedule and the second scan schedule dynamically in response to mission requirements. This exemplary embodiment or another exemplary embodiment may further provide that wherein the joint MDFG is in operative communication with a user-specific scan schedule optimization algorithm that optimizes the first scan schedule and the second scan schedule dynamically in response to environmental changes. This integrated approach of the receiver assets to optimize overall system performance is scalable on multiple receivers, across multiple systems on a platform, and across multiple platforms.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a schematic overhead view of an exemplary platform employing the electronic warfare asset management system according to one aspect of the present disclosure.

FIG. 2A (FIG. 2A) is an operational view of a first phase prior to initiating a mission into a hostile environment according to one aspect of the present disclosure.

FIG. 2B (FIG. 2B) is an operational view of a portion of a second phase after the initiation of a mission into a hostile environment according to one aspect of the present disclosure.

FIG. 2C (FIG. 2C) is an operational view of another portion of a second phase after the initiation of a mission into a hostile environment according to one aspect of the present disclosure.

FIG. 3 (FIG. 3) is an exemplary flow chart depicting a first process in electronic warfare asset management system according to one aspect of the present disclosure.

FIG. 4 (FIG. 4) is an exemplary flow chart depicting a second process in an electronic warfare asset management system according to one aspect of the present disclosure.

FIG. 5 (FIG. 5) is a flow chart depicting another exemplary method or process of the present disclosure.

FIG. 6 (FIG. 6) is a flow chart depicting another exemplary method or process of the present disclosure.

FIG. 7 (FIG. 7) is a flow chart depicting another exemplary method or process of the present disclosure.

Similar numbers refer to similar parts throughout the drawings.

### DETAILED DESCRIPTION

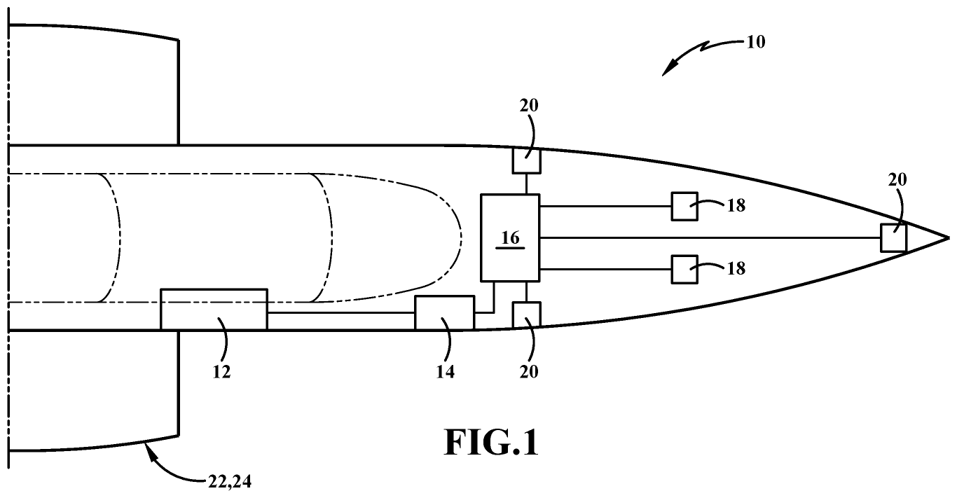

Electronic warfare (EW) systems are commonly used on many different platforms (referenced herein as platform 22) including manned and unmanned aircraft, vehicles, ships, and/or land-based installations. Generally speaking and with general reference to FIG. 1, an EW asset management system of the present disclosure, herein referred to as EW system and generally referenced at 10, may include one or more digital processors 12, one or more frequency converters 14, one or more transceivers 16, one or more transmit antennas 18, and one or more receiving antennas 20. These EW system 10 components, namely, digital processors 12, frequency converters 14, transceiver 16, transmit antennas 18, and receiving antennas 20, may generally be referred to as assets. In one embodiment there is a single antenna for transmission/reception. Therefore it will be understood that the term “assets” as used herein, may refer to any or all of these components, unless specifically stated otherwise.

The one or more digital processors 12 may be a computer, processor, logic, or series of logics including or in communication with a non-transitory storage medium, the digital processor 12 capable of carrying out and executing a set of instructions or processes encoded thereon as further discussed herein. According to one aspect, digital processor 12 may be operationally connected to other assets. According to another aspect, digital processor 12 may be remote from other EW assets and may be in wired or wireless communication therewith. The connectivity and communication between other EW assets and the digital processor 12 may therefore vary depending upon the desired implementation and installation parameters of EW system 10, as discussed herein.

The one or more frequency converters 14 may be an electronic or electromechanical device operable to convert the alternating current of one frequency to the alternating current of another frequency. Frequency converters 14 may be any type of frequency converters suitable for the desired implementation, including circuits converting radio frequency signals such as those that utilize a local oscillator and/or frequency mixer to generate different frequencies from the input. According to one aspect, frequency converters 14 may be in communication with one or more of digital processors 12.

The one or more transceivers 16 may be operable to both transmit and receive radio waves via the transmit antennas 18 and receiving antennas 20, as discussed herein. Transceiver 16 may include any type of transmitter, including but not limited to communications transmitters, radar transmitters, or signal jamming transmitters. Transceiver 16 may further include any type of receiver, including but not limited to radio receivers, global navigation receivers, or very high frequency omni-direction range (VOR) receivers. According to one aspect, the one or more transceivers 16 may include more than one type of transmitters and receivers and/or may be operable to transmit and/or receive more than one type of electromagnetic signal via the transmit and receiving antennas 18, 20 as discussed further herein. According to another aspect, transceivers 16 may be transmitter-receivers that do not share any common circuitry or housing. According to another aspect, transceivers 16 may be both a transmitter and a receiver realized as separate assets within EW system 10, as dictated by the desired implementation parameters.

Transceiver 16 may be in communication with frequency converters 14 and/or digital processor 12 through a wired or wireless connection. According to one aspect, transceiver 16 may be in communication with frequency converter 14, which is then in serial connection with processor 12 such that all communications between transceiver 16 and processor 12 may pass through frequency converter 14. According to another aspect, transceiver 16 may be in connection with processor 12 through frequency converter 14 and separately from frequency converter 14 such that some communications between transceiver 16 and processor 12 may pass through frequency converter 14 while other communications between transceiver 16 and processor 12 may not.

With general reference to transmit antennas 18 and receiving antennas 20, these antennas 18, 20 may be monopole, dipole, and/or directional antennas or any combination thereof and may be arranged in any desired configuration appropriate for the installation conditions. According to one aspect, each of these transmit and receiving antennas 18, 20 may be an antenna array having multiple antenna elements or antennas contained therein.

Transmit antennas 18 may be any antenna or antenna array capable of broadcasting a signal out from platform 22. According one aspect, one or more of transmit antennas 18 may broadcast electromagnetic signals originating from transceiver 16 or from other assets within EW system 10, as discussed further herein.

Transmit antennas 18 may be in communication with transceiver 16 through a wired or wireless connection. Transmit antennas 18 may further be in communication with other EW system 10 assets, such as frequency converter 14 and/or processor 12 through wired or wireless connections. According to one aspect (not shown), transmit antennas 18 may be in connection with transceiver 16 through frequency converter 14 such that signals to be transmitted from transmit antennas 18 may be passed through frequency converter 14 prior to being broadcast.

Receiving antennas 20 may likewise be any antenna or antenna array capable of detecting and receiving signals originating away from EW system 10. According to one aspect, receiving antennas 20 may be optimized to detect and receive signals having one or more polarizations across varying frequency bands and/or having varying dynamic range. According to another aspect, different receiving antennas 18 may be optimized and/or calibrated to detect and receive signals of differing polarization and/or of difference frequencies or ranges.

Receiving antennas 20 may be in communication with transceiver 16 through a wired or wireless connection. Receiving antennas 20 may further be in communication with other EW system 10 assets, such as frequency converter 14 and/or processor 12 through wired or wireless connections. According to one aspect (not shown), receiving antennas 20 may be in connection with transceiver 16 through frequency converter 14 such that signals received by receiving antennas 20 may be passed through frequency converter 14 prior to reaching transceiver 16.

According to one aspect, it may be desirable to have multiple receiving antennas 20 and/or receiving antenna 20 arrays spaced apart from one another on a platform 22 to help in determining characteristics of an incoming signal that is detected by receiving antennas 20. For example, having receiving antennas 20 spaced apart may allow discrimination of characteristics within an incoming radio signal that may indicative of the source direction and/or geolocation of the emitter producing the incoming signal. Therefore, it is understood that these receiving antennas 20 may be placed at positions across a platform 22 as dictated by the type of platform 22 and/or the implementation parameters.

In one particular exemplary embodiment, system 10 is comprised of a plurality of receive antennas or receivers 20 that have different bandwidths relative to each other. In another embodiment, there are at least two receivers that have differing operative bandwidths. More particularly, there may be a first receiver 20A that is operative at a first bandwidth and a second receiver 20B that is operative at a second bandwidth, wherein the first bandwidth and the second bandwidth are different.

In this regard, system 10 having at least two receivers that have differing operative bandwidths allows the different receivers 20A, 20B to work together in order to intercept different signals. The plurality of receivers 20, wherein at least two receivers from the plurality have differing operative bandwidths, use an algorithm or a method implemented by a computer program product that allows the receivers to automatically allocate resources to other receivers with different capabilities. This creates a cumulative response time that allows the system to better detect modern emitters.

Multiple receivers with different bandwidths can use an algorithm, process, logic or technique to allocate resources to each other in order to optimize their performance and enhance the system's capabilities in detecting modern emitters. The algorithm works by assigning the most suitable receiver to intercept a particular signal based on its characteristics, such as frequency, polarization, and signal strength. For instance, if a signal is weak and requires a high sensitivity receiver, the algorithm would allocate resources to the receiver with the highest sensitivity. On the other hand, if a signal is strong and requires a wide bandwidth, the algorithm would allocate resources to the receiver with the widest bandwidth.

The automatic resource allocation algorithm/technique may create a cumulative response time by allowing multiple receivers to work together in a coordinated manner. This means that the system can intercept and process multiple signals simultaneously, reducing the time required to detect and locate modern emitters. As a result, the system can respond more quickly to evolving threats and reduce the risk of being detected by the emitter.

Using multiple receivers with different bandwidths addresses the issue of receivers being limited by finite bandwidth, instantaneous dynamic range, and finite polar range because it allows the system to cover a wider range of frequencies and intercept different types of signals. Different receivers can be optimized to intercept different types of signals based on their bandwidth, sensitivity, and other parameters. This allows the system to adapt to changing situations and handle modern emitters that use LPI techniques. By working together, the multiple receivers create a more comprehensive and effective electronic warfare system that is better equipped to handle modern threats.

According to one aspect, transmit antennas 18 and receiving antennas 20 may be the same antenna assets or may be separate assets in communication therebetween. According to another aspect, transmit antennas 18 and receiving antennas 20 may be separate assets that are isolated and remote from each other such that their operations, as discussed further herein, do not overlap.

Depending upon the desired implementation and use, EW system 10 may include additional assets, such as one or more countermeasures, including flares, chaff, squibs, and/or jamming technologies. EW system 10 may further include offensive assets, such as ballistic weapons, such as guns, and/or guided munitions, such as missiles. All EW system 10 assets, including digital processors 12, frequency converters 14, transceivers 16, transmit antennas 18, receiving antennas 20, and any additional assets included therein may be in communication directly or indirectly, such as through another asset component, through wired or wireless connections.

EW system 10, as discussed herein, may be carried on a platform 22 such as within the body or fuselage of an aircraft 24, as shown in FIG. 1 and discussed further below or external to the aircraft 24 on a pod or support platform. EW system 10 may have any arrangement or configuration on the platform 22 provided that any desired or necessary connections and/or communications between the components thereof are maintained. Although shown in a generalized configuration in FIG. 1, it will be understood that each individual asset may be placed and/or located at any position within or on platform 22. Accordingly, it will be understood that the particulars of the platform 22, e.g. aircraft 24, on which EW system 10 is carried may dictate the positioning and/or placement of individual assets thereon. The number, size, and type of assets employed may likewise vary depending on the specific platform 22 employed, and may be limited by the available space thereon, as well as by the load capacity of an individual platform 22. According to another aspect, assets may be moved or moveable between multiple positions depending upon the desired use for a specific mission or operation, or as dictated by the particulars of the platform 22 being used, as discussed further herein. The specific configuration and placement of EW system 10 assets on a platform 22 is considered to be the architecture of the EW system 10. This architecture may be specifically and carefully planned to meet the needs of any particular EW system 10. The architecture may also be changed or upgraded as needed.

Further, according to one aspect, the processes and systems described herein may be adapted for use with legacy systems, i.e. existing architecture, without a need to change or upgrade such systems. Specifically, the MDFG may allow an operator or engineer to evaluate the assets present in a legacy system and may allow of optimization thereof without changes to the architecture. The evaluation of the EW system architecture and/or changes thereto is discussed further with reference to the operation of EW system 10 below.

Platform 22 may be any platform performing EW operations, including but not limited to land-based installations, vehicles, ships, and/or manned or unmanned aircraft or the like. It will be understood that the systems and methods described herein may be adapted for use with platform 22 regardless of the implementation or form thereof. However, as used herein, and for purposes of simplicity and clarity, an exemplary platform 22 will be discussed as an aircraft, indicated as 24. Accordingly, aircraft 24, as used further herein is therefore understood to be a representative example of a platform 22 and not a limiting embodiment thereof. Alternatively, platform 22 may also perform civilian operations, such as those require by a cell tower. Thus, while the present disclosure is primarily discussed with reference to EW operations and scenarios, it should be understood that the teachings detailed herein are also applicable to civilian uses or operations.

Having thus described the general configuration and components of EW system 10, the operation and method of use thereof will now be discussed.

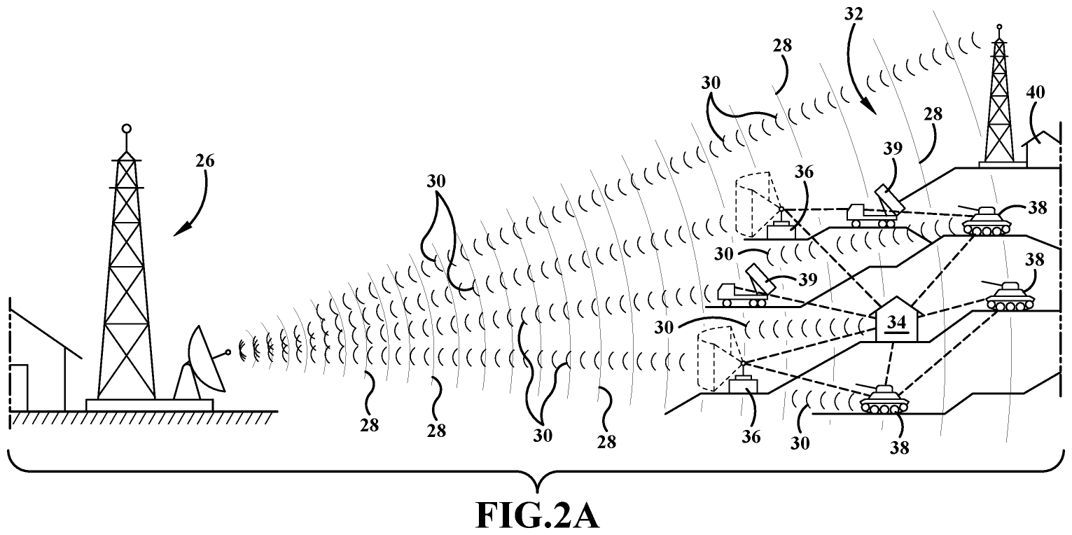

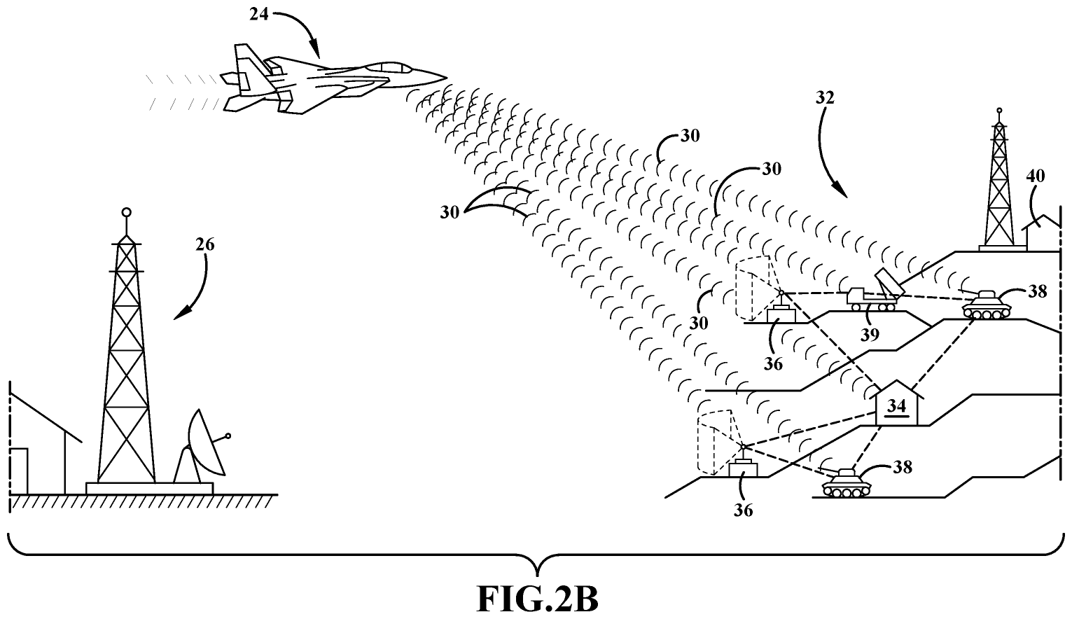

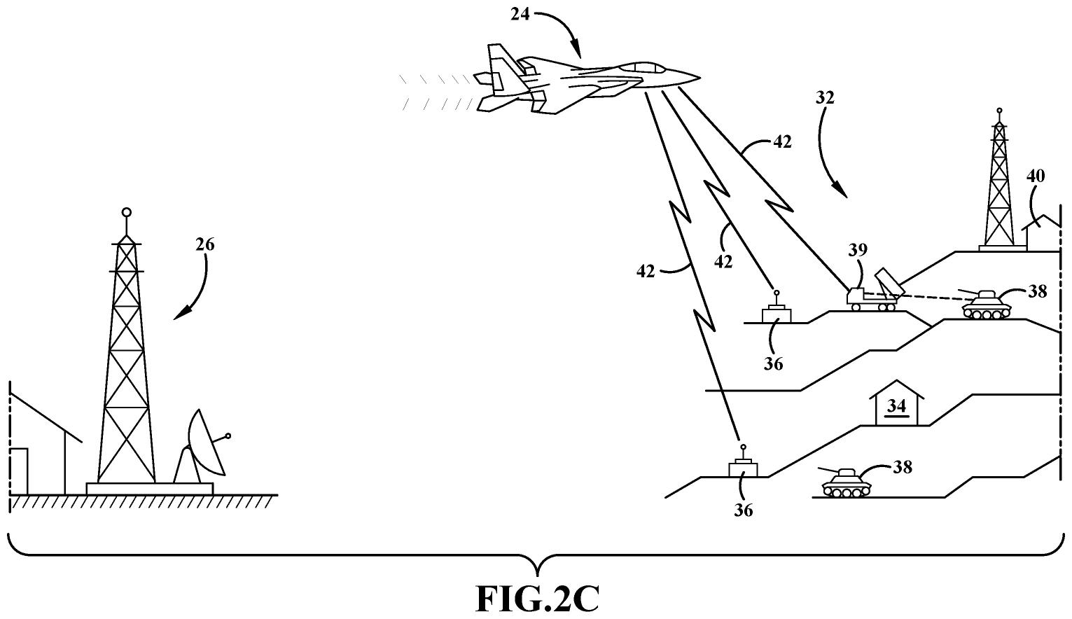

With reference to FIG. 2A, prior to the start of a mission into a hostile environment, information about the area of operations, herein referred as theater of operations 32, or simply theater 32, may be gathered utilizing a long-range transceiver 26, as well as by other information gathering techniques, such as prior missions in the same theater 32, prior mission data files, satellite, aerial, and/or ground surveillance, and/or information gathered through other means. This information gathering phase may occur over an extended period of time, depending on the desired results. For example, if a single mission is to be provided into a specific theater 32, the information gathering stage may be only a few hours or days. According to one aspect, the information gathering stage may be a period not less than twenty-four hours prior to the initiation of a mission. In another example, the information gathering state may be a period less than twenty-four hours. If repeated missions are expected, or if long-term presence is anticipated, the information gathering stage may be weeks or months, or may be an ongoing process covering many missions over an extended period of time. According to one aspect, the period of time during which the information gathering stage may extend may begin at the time a presence is established in the theater and last until the initiation of a particular mission. As discussed further below, additional information about the theater 32 and the emitters present therein may be useful to the processes disclosed herein.

According to one aspect, long-range transceiver 26 may broadcast or transmit a signal 28 (represented by large arcuate lines in FIG. 2A) into or towards theater 32 from some distance while monitoring for bounce back from signal 28. For example, signal 28 may be a radar pulse or series of pulses that impact objects within theater 32 and reflect back to long-range transceiver 26. Long-range transceiver 26 may then analyze characteristics of the signal 28 that has reflected back to ascertain what the object was that reflected the signal 28 back. Further, long-range transceiver 26 may simultaneously monitor and/or scan for emitter signals 30 (represented by small arcuate lines in FIGS. 2A and 2B) being broadcast from emitters within theater 32. For example, enemy vehicles and/or installations may emit radar pulses of their own. Long-range transceiver 26 may detect these pulses and may use data from these pulses to determine information such as the type of emitter, the distance, direction, and/or geolocation of the emitter. Detection of these pulses may also provide information relating to the pulses themselves, such as the frequency, amplitude, polarization, the time the pulse was sent, and the pulse repetition interval, i.e. how often the pulses are emitted, and the revisit rate, i.e. how often the long-range transceiver sends pulses towards the platform. The information gathered from signal 28 and emitter signals 30 can be used to identify and create a profile of each specific emitter operating within theater 32 which may be utilized during an active mission, as discussed further below. This profile of each emitter may be referred to as a tracked identification which is a historical view of each emitter and its activities over time.

According to one aspect, as illustrated in the figures, long-range transceiver 26 may be a land-based structure or series of structures that may be part of a military base of operations. According to another aspect, long-range transceiver 26 may be an aircraft, ship, satellite, commercial radar, or mobile installation. According to another aspect, multiple structures, aircraft, ships, satellites, and/or mobile installations may be utilized to perform the operations of long-range transceiver 26.

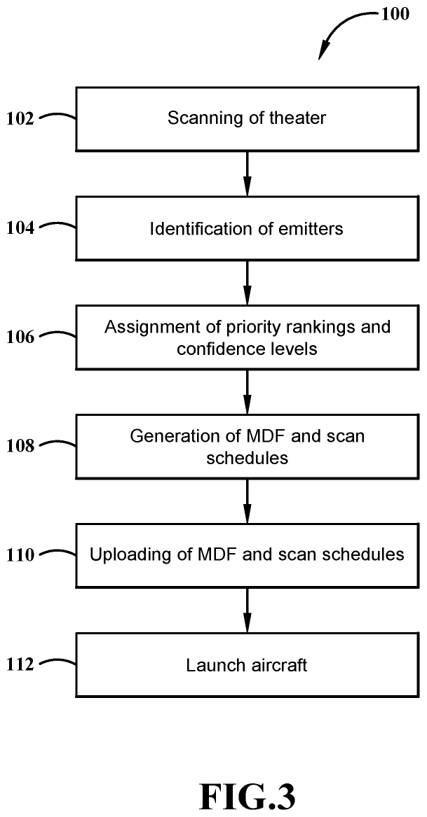

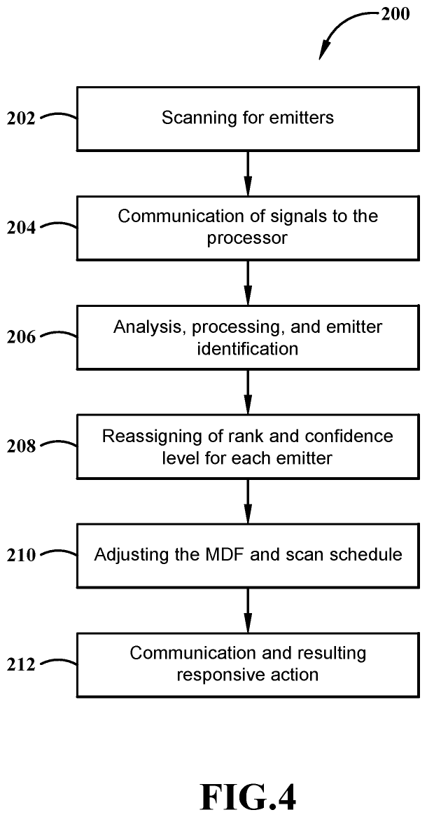

The processes described herein may best be illustrated in two phases, with each of these two phases illustrated by way the examples shown in FIGS. 2A-2C and by way of exemplary flow charts shown in FIGS. 3 and 4, respectively. Specifically, FIG. 2A represents an example of the actions during the first phase, which is then shown in the flow chart in FIG. 3 as process 100. FIGS. 2B and 2C represents examples of the actions during the second phase, which is then shown in the flow chart in FIG. 4 as process 200.

With reference then to FIGS. 2A and 3, process 100 may cover the period of time prior to launching an aircraft 24 on a mission, including some or all of the information gathering procedures described above. Thus process 100 is considered the mission planning period. During process 100, an operator may utilize a mission data file generator (MDFG) to prepare and generate a mission data file (MDF) and/or a scan schedule. However, the scan schedule of the present disclosure is an adaptive scan schedule based on the signals 30 that are encountered during operation of system 10 during process 100 as detailed herein. The operator may be one or more persons which may optionally include the pilot/operator of an aircraft 24 that may be used in a subsequent mission.

The MDFG may be a computer program or suite of programs designed and built for this purpose, and may be stored on a local computer having a storage medium, or may alternatively be stored on a remote system with which the operator is in communication, or may alternatively be stored in the cloud. According to one aspect, the MDFG may be a standard software application that is used to generate MDFs.

The MDF is the data file that may be provided to the pilot of an aircraft 24 giving the mission objectives, as well as providing information to the pilot relating to what types of emitters are present in theater 32, the density of emitters, which of those emitters may pose a threat to the pilot, the aircraft, and/or the mission itself. The MDF may further contain mission objectives that may be assigned according to the information regarding the emitters present in theater 32.

The scan schedule is a determination of an operational schedule of the assets on EW system 10 as they are expected to be used during a mission. Specifically, the scan schedule may be a program or schedule that dictates when and how long each asset may be used during the mission. For example, the scan schedule may provide which frequency bands or sub-bands to scan, how often each frequency band or sub-band is scanned, how long each asset will dwell within a specific frequency band or sub-band during each scan for a dwell time, and the order in which each asset may scan its assigned frequency bands or sub-bands during the mission. The scan schedule may likewise provide similar scheduling of asset use for other measurable parameters, such as dynamic range, polarization, scan channels, and the like. However, the scan schedule of the present disclosure is adaptive, which refers to it having the ability to dynamically change midflight or mid-operation in response to signals 30 that are received by the one or more receivers 20 or other assets.

Process 100 may begin the scanning of theater 32, indicated as reference 102 in the flow chart, which differs from the information gathering procedures discussed above in timing in that the information gathering procedures above may be performed at any time, including prior to, during, or subsequent to a mission. It is further contemplated that information gathering may occur on a constant or near constant basis while a presence is desired in the area of theater 32. Scanning 102 of theater 32, however, is contemplated to be done immediately prior to a mission into theater 32 is to occur. Scanning 102 may include emitting signal 28 into theater 32 and/or monitoring for emitter signals 30 originating from theater 32 using the same or similar techniques as those described above. Data from the scan 102, including information regarding the distance, direction, and/or geolocation of any emitters in theater 32, along with the frequency, amplitude, polarization, and send time of emissions therefrom may be collected for further use in process 100, as discussed below. The scanning step 102 may provide a measured identification of each emitter, which is the measurement of the above parameters occurring at a single instance, i.e. the time at which scan 102 is performed.

Once a scan 102 of theater 32 is complete, the measured identification data gathered by the scan may be compared with and/or combined with long term tracked identification data collected during information gathering efforts and used to identify the emitters present in theater 32. The identification of emitters is indicated as 104 in FIG. 3. By way of the example illustrated in FIG. 2A, theater 32 may have several different types of emitters and emitter targets indicated. Specifically, theater 32 may include a command center 34, one or more radar installations 36, and one or more enemy vehicles. As shown in FIG. 2A, representative examples of enemy vehicles may include tanks 38 and mobile missile batteries 39, however, it will be understood that enemy vehicles may further include trucks, personnel carriers, or any other unit, including stationary anti-air installations. As further illustrated in the example shown in FIG. 2A, theater 32 may also have a civilian radar installation 40 present. For example, a broadcast radio station or air traffic control systems may be located within theater 32.

In operation, the numbers and types of emitters present within the theater may vary according to numerous factors, including but not limited to, time of day, weather conditions, terrain conditions, enemy movements, and the like. Thus, as part of the identification 104 of emitters during process 100, the operator may evaluate which emitters are actually detected in the scanning step 102 as well as emitters that are expected to be present within theater 32 during the mission based on prior intelligence and information gathering. Further, the identification step 104 is contemplated to identify the geolocation and specific characteristics of emitters present or expected to be present in theater 32, as discussed further herein.

Once the operator/system is armed with data relating to the number, type, and location of emitter, as well as the characteristics thereof, the operator may then assign a confidence level to each and every emitter present within theater 32. These confidence levels may serve as a ranking, or weighting system, used to identify the priority of each emitter for the upcoming mission. Priority may be fluid or variable based on the mission objectives, however, as a general and non-limiting example, priority may be defined by lethality, i.e., the more lethal the emitter, the higher priority it is assigned. The assignment of priority rankings and confidence levels are indicated in FIG. 3 as reference 106 and may be used later to inform a decision by a pilot on mission, as discussed below.

The assignment of a priority ranking and confidence level to any given emitter may be based on a number of factors including the measured identification of the emitter, the tracked identification of the emitter, as well as derived parameters, which are parameters derived from the tracked identification. One example of a derived parameter may include revisit rate, i.e. how often or fast an emitter comes online over time. The specific factors considered in assigning rankings and confidence levels may vary depending on the mission objectives, as well as on the observed emitter presence, but generally speaking, these rankings and confidence levels may be assigned according to the observed characteristics of any given emitter within theater 32.

The rankings and confidence levels are important in the generation of the MDF and scan schedules, which is the next step is process 100, indicated as reference 108 in FIG. 3. Armed with emitter profiles, including measured and tracked identifications, rankings, confidence levels, and information relating to the density of emitters and their location within theater 32, an operator may utilize the MDFG to apply one or more algorithms or processes therein to determine how best to utilize the EW system 10 and its related assets during the upcoming mission.

Specifically, the MDFG may allow the operator to use these algorithms or processes to evaluate the existing architecture of EW system 10 to determine what specific assets are present and to further determine and prepare the scan schedule that is optimized to the existing architecture to be effective in theater 32 based on the emitters present as detected therein. The MDFG may also allow an operator to further evaluate the existing architecture of EW system 10 to allow changes and adjustments thereto. For example, the algorithms and processes within the MDFG may allow the operator to analyze theater 32 based on the existing emitters present therein. The MDFG may then produce a recommendation for a different architecture than what is currently installed on aircraft 24. Further according to this example, recommendations from the MDFG may include adjustments to EW system 10 assets such as the number or type of receiving antennas 20, transmit 18, transceiver 16, and the like.

According to another aspect, as discussed previously herein, the MDFG may allow evaluation and utilization of legacy systems in the implementation of the processes discussed herein. Specifically, EW system 10 assets may be legacy assets which may be retrofitted with software or other instructions to accomplish the features of the present disclosure without significantly increasing size, weight, power, or cost to existing legacy EW systems. Processes 100 and 200 may be uploaded to existing legacy assets or may be added thereto through the use of an additional memory module, including an additional non-transitory storage medium, or through the use of temporary memory devices, such as flash memory or the like. Accordingly, the MDFG may allow these existing legacy assets to be optimized and used without adjustments thereto.

According to one aspect, the MDFG may further employ additional algorithms or processes to allow many assets in EW system 10, such as transmit antennas 18 and/or receiving antennas 20 to operate in parallel with other assets, thus allowing a broader coverage of the electromagnetic spectrum in both transmitting and scanning for signals during the upcoming mission.

Once the architecture has been evaluated and configured as desired for the mission parameters, the MDFG may produce the MDF and scan schedules (step 108), which are then uploaded or otherwise communicated to the digital processor 12 onboard aircraft 24 and may also be provided directly to the pilot. The uploading of the MDF and scan schedule is indicated as reference 110 in FIG. 3. The uploading 104 of MDF and scan schedule is the last step of the mission planning period, and process 100 ends when the aircraft 24 takes off or the mission is otherwise initiated. The launch of aircraft 24 is indicated as reference 112 in FIG. 3 and marks the initiation of the mission into theater 32.

Previous EW systems typically end with the start of the mission in that no further adjustment are made to the MDF and/or the scan schedule once the aircraft has taken off and is operating “on mission.” In other words, prior EW systems generate an MDF and scan schedule, and that is then fixed for the entire duration of the mission. By way of a simplified example, if scan schedule in a prior EW system dictates that one of the receiving antennas scans in a particular frequency band for the entire mission, that antenna is locked to that frequency band. If there are zero active emitters broadcasting in that frequency band during the mission, that asset is wasted for the duration of that mission. Worse, if a new emitter comes online in a frequency band that isn't in the original scan schedule, that emitter is may not be detected, or may be detected later than desirable. If that new emitter proves a threat to the aircraft, it may result in a failed mission, a lost aircraft, and/or a lost pilot.

As technology advances, many, if not all, of the emitters in a modern theater 32 are likely to be low probability of intercept (LPI) emitters which tend to be very agile. This agility (i.e., the ability to jump or move throughout the range of available broadcast frequencies as well as in other parameters) makes these LPI emitters virtually programmable in an effort to thwart detection and interception thereof. By way of one non-limiting and simplified example, an LPI emitter may be analogous to a civilian radio station that constantly and apparently randomly changes its broadcast station periodically and randomly over time. This would make it difficult for a person listening to a radio show on that station to follow along with that show as they would constantly have to scan through the entire radio dial to chase the signal. As applied to these LPI emitters, modern technology allows these emitters to move across frequency bandwidth as well as in parameters, such as Pulse Width (PW), and Pulse Repetition Interval (PRI), dynamic range and the like. Further, LPI emitters have the ability to broadcast and/or emit in shorter bursts allowing them to remain offline for longer periods of time. Each of these abilities, coupled with the ability of modern radars to re-program themselves, further reduces the likelihood of interception, increasing the difficulty to generate the MDF using the MDFG prior to the mission.

Accordingly, and in contrast to prior solutions, the EW system 10 of the present disclosure utilizes the second phase, process 200, as shown in FIGS. 2B, 2C, and 4. Specifically, process 200 begins after process 100 ends, i.e. after the aircraft 24 is in flight and on mission. Once aircraft 24 is in flight, process 200 begins by utilizing the MDF and scan schedule (which represent the initial performance expectation for the upcoming mission) that were produced (step 108) and uploaded (step 110) during process 100 as a default and begins the mission normally. While in flight, aircraft 24 continues to scan for emitters in theater 32 according to the default scan schedule. Scanning for emitters, indicated as reference 202 in FIG. 4, may be accomplished by both active and passive means such as actively generating a signal and listening for bounce back, or by passively listening for signals generated by the emitters within theater 32.

As signals are collected by aircraft 24, or more specifically, as signals hit receiving antennas 20, they are communicated to processor 12 via transceiver 16 and/or frequency converter 14. The communication of signals to the processor 12 is indicated as reference 204 in FIG. 4. Processor 12, as discussed above, may have a non-transitory storage medium operationally connected thereto with an operational flight program (OFP) encoded thereon.

The OFP may be software or a suite of software that includes one or more algorithms and/or processes to analyze and process data in real-time as it is received by processor 12. As it relates to process 200, when the processor 12 receives signal data via the receiving antennas 20, the OFP may compare this measured data to the MDF, the default scan schedule, and/or to a stored database populated with data relating to the measurement identification, tracked identification, and/or the derived parameters of the emitters in theater 32 to identify each emitter within theater 32. The analysis, processing, and emitter identification step is indicated as reference 206 in FIG. 4.

Analyzing and processing the incoming signal data (in step 206) to identify the emitters in theater 32 in real-time may provide the aircraft 24 and/or pilot with a continuous, up-to-date view of theater 32 as the mission progresses because the real-time processing by the OFP is based on the actual activities occurring in theater 32 as detected throughout the mission. Armed with this information OFP may then re-rank the emitters based on their current, real-time status and position within theater 32. Specifically, OFP may reassign rankings and confidence levels to each emitter based on real-time changes in the operational environment. The reassigning of rank and confidence level for each emitter is indicated as reference 208 in FIG. 4.

Having thus reassigned rankings and confidence levels to each emitter based on real-time detection data, the OFP may adaptively adjust the MDF and scan schedule to account for these real-time changes. Adjusting the MDF and scan schedule is indicated as reference 210 in FIG. 4. These changes may be further communicated to aircraft 24 and/or pilot of aircraft 24, who may utilize the updated, real-time MDF and scan schedule to act accordingly. This communication and resulting action is indicated as reference 212 in process 200. In one embodiment, the communication and resulting responsive action of step 212 is the final step in process 200, however it is not required to be the final step in process 200.

Process 200 may be repeated on a continuous basis throughout the entirety of the flight mission, which may increase the likelihood of a successful mission while providing the highest probability of intercept of each LPI emitter present within theater 32. Process 200 further results in a higher probability that the highest priority emitters are detected with the fastest response times, thus reducing the occurrence of bad outcomes.

With reference to FIGS. 2A-2C, process 200 will be explained by a non-limiting example scenario that is depicted therein.

As shown in FIG. 2A, theater 32 is populated with one command center 34, two radar installations 36 that are actively scanning nearby airspace (indicated by the dashed line polygons emitted therefrom), three tanks 38, two mobile missile batteries 39, and a civilian radar installation 40. This example assumes that each of these structures or vehicles represents a single emitter within theater 32. Further, as shown in FIG. 2A, each of the military emitters (all emitters excluding the civilian radar installation 40) is in communication with other military emitters. This communication is represented but dashed lines extending between emitters. As FIG. 2A illustrates the state of theater 32 prior to the start of a mission, the MDF and scan schedule would be generated by the MDFG and uploaded to an aircraft 24 based on the state of theater 32 shown therein. In this example, missile batteries 39 would be given the highest priority, as they present the highest threat to aircraft 24, while the civilian radar installation 40 may be given the lowest priority. Further according to this example, tanks 38 may be given a lower priority than other military targets as they are not typically considered a significant threat to aircraft 24 that operate at high altitudes and/or high speeds. Accordingly, the default MDF and scan schedule will allocate more assets to tracking the missile batteries 39 than they will the tanks 38, for example.

Once aircraft 24 has taken off and is in route to theater 32, process 200 begins with the aircraft 24 scanning (step 202) for emitters in theater 32. This is illustrated in FIG. 2B where aircraft 24 is shown receiving emitter signals 30 from various emitters within theater 32. It is noted however, that in FIG. 2B, the command center 34 and both radar installations 36 remain online; however, one of the original two mobile missile batteries 39 and one of the three tanks 38 are now offline at the particular moment depicted. As the receiving antennas 20 of aircraft 24 receives signal 30 from these emitters, the signal data is communicated to processor 12 (step 204) where the OFP may analyze the data (step 206), reassign rankings and confidence levels (step 208) and adjust the MDF and scan schedule (step 210) to reallocate assets to the emitters as present in theater 32. In this example, with missile batteries 39 still posing the highest threat to aircraft 24, the single missile battery 39 remains the highest priority, however, the re-ranking and adjusting of MDF and scan schedule can reallocate assets from the other, now offline, missile battery 39 and direct those assets to other, still online emitters. Similarly, the assets that were originally allocated to the third tank 38 that is now offline may be reallocated to other online emitters.

Further according to this example, as one of the highest priority targets from the default MDF and scan schedule is now offline, mission objectives in the MDF may change as well. As may be reasonably expected, with a high priority target, such as a missile battery 39, is no longer online, a mission objective may shift from avoiding or jamming that missile battery 39 to avoiding, engaging, or jamming a secondary target. As shown in FIG. 2C, The sole remaining missile battery 39 and both remaining radar installations 36 are being jammed by aircraft 24 via jamming signal 42. If the previously identified missile battery 39 was still online, this example assumes that it too would have been jammed or intentionally avoided. Instead, OFP allowed the pilot of aircraft 24 to make adjustments in real-time to change the mission objectives. These changes to priority are based upon the real-time evaluation of the environment, the mission objectives, the range/operating intent of each radar, and the current flight path.

Further, adaptively adjusting the MDF and scan schedule (i.e., step 210) to reallocate assets to the emitters as present in theater 32 may be accomplished in a variety of manners. According to one example, the scan schedule is adaptive based on the emitter signals 30 received at the receiving antennas 20. In this example, the two receivers 20A, 20B have differing bandwidths. If the emitter of signal 30 is a LPI emitter, then it has the capability of “hopping” between different frequency bands for its transmission. The receivers 20A, 20B (amongst other receivers) are capable of detecting the presences of signal 30 from the LPI emitter when it hops between different frequencies. As such, creating an adaptive scan schedule or adjusting the scan schedule (step 210) is accomplished by having a plurality of receivers 20 with differing bandwidths or different functional parameters so as to allow the scan schedule to adaptively adjust spectral detection bands in response to frequency hopping performed by the LPI emitter. This creates a cumulative response time that allows system 10 to better detect modern LPI emitters.

With continued reference to the adaptive scan schedule performed at step 210, it is noteworthy that as technology evolves and advances, modern radar emitters are becoming increasingly more difficult to detect and ID. Modern emitters utilize LPI techniques in order to make themselves less detectable. These LPI techniques include multiple dimensions of agility, minimizing number of pulses emitted, and managing the power transmitted. The EW system 10 addresses the need for an electronic warfare system to better handle these evolving modern threats. Scan schedules use receivers to intercept various environmental signals. As previously indicated, current receivers have limitations such as finite bandwidth and dynamic range and thus must ‘scan’ over the special and spectral space to detect active emitters in an environment. If the only goal of an EW system is to intercept radar emissions, then the scan schedule would be a sequence of very short dwells with a high rate of revisits to the same spectral space. While this would optimize that EW system's ability to intercept emitters, it would also prevent the system from accurately identifying which radar the emission came from. Typically, the identification process should have as much information about an emitter as possible in order to optimize the EW system's ability to report Correct and Unambiguous Identification (CUID). To achieve CUID, a scan schedule that ‘stares’ for long periods of time to collect as much contiguous information on an emitter as possible is desired. This causes a direct conflict between the system being optimized for POI and being optimized for CUID.

To optimize POI or CUID, the EW system 10 of the present disclosure provides an adaptive scan schedule that implements a technique or an algorithm that optimizes for POI, but also allows for managed extensions to achieve CUID performance while minimizing the impact to the POI performance. The managed extensions include one or more extensions for direction finding (DF), geo-location, polarization, gain, required configurations, and ID parameters such as pulse repetition interval (PRI) measurements. Additionally, to minimize these managed extensions effect on POI performance, one particular embodiment of the present disclosure may provide that the managed extensions are only allowed to take place when necessary, and only take place when the emitter of interest is present. However, other embodiments may execute or permit operations of these managed extensions at other times. In this exemplary embodiment or another exemplary embodiment of EW system 10, other controls may be implemented to run these managed extensions only for the amount of time necessary to collect the required information. This may be performed through programming a minimum collection time and maximum collection time, as well as a desired pulse collection count. This pulse collection count permits the EW system 10 to only extend a dwell until the collection count is satisfied (not to the maximum collection time), and thus minimize impact to the EW system's 10 POI performance. In one particular embodiment, the pulse collection count is also dynamic (e.g., adaptive) based on what information needs to be collected. Additionally, in another embodiment of EW system 10 the scan schedule has a planned expansion factor. This planned expansion factor allows the scan schedule to account for the managed expansions and develop a scan schedule that maintains POI performance even as the scan schedule dwells are expanded.

The managed extensions in the EW system 10 are employed to enhance the system's capabilities beyond basic point of interest POI optimization, specifically for achieving CUID. These extensions include various techniques or algorithms such as DF, geo-location, polarization adjustments, gain modifications, and configurations related to identification parameters like PRI measurements. These extensions are activated strategically to gather additional data or refine existing data when necessary, thereby improving the overall performance of the EW system 10 in identifying and characterizing emitters of interest.

The managed extensions refer to supplementary functionalities integrated into the EW system 10 to augment its primary capabilities, particularly in achieving CUID of emitters. These extensions encompass a range of techniques and algorithms aimed at enhancing the system's ability to collect, process, and analyze electromagnetic signals. DF determines the direction from which electromagnetic signals originate. Geo-location estimates the geographical location of signal sources. Adjusting the polarization of antennas to improve signal reception. Modifying the amplification (e.g., gain) of received signals to optimize signal-to-noise ratio. PRI adjustments can be made for accurate identification. These extensions are selectively activated based on operational requirements and the presence of emitters of interest to minimize impact on POI performance while maximizing CUID effectiveness.

The expansion factor in the scan schedule of the EW system refers to a planned allowance for extending dwell times to accommodate managed expansions without significantly affecting POI performance. This factor is advantageous for maintaining the balance between optimizing CUID performance through managed extensions and ensuring efficient utilization of resources without compromising the system's primary objective of identifying points of interest. The expansion factor allows the scan schedule to flexibly adapt to the activation of managed extensions by incorporating additional time for data collection and processing. By considering the planned expansions in the scan schedule, the system can effectively allocate resources and adjust dwell times to accommodate the execution of managed extensions while minimizing disruption to POI performance. This ensures that the system remains responsive to evolving operational needs and can adapt its scanning strategy to effectively handle diverse electromagnetic environments.

When the algorithm in the EW system processes the collected data from the at least one incoming signals to determine the POI location, the resulting POI location is typically reported to a designated interface within the EW system. This interface could be part of the system's user interface, a central command and control station, or a communication link to external systems or operators.

The reported POI location serves as actionable intelligence for operators or automated systems to make informed decisions regarding threat assessment, targeting, or further analysis. Depending on the system's architecture and operational requirements, the reported POI location may trigger various responses, such as alerting operators, updating tactical displays, or initiating countermeasures.

Updating the scan schedule based on the reported POI location is possible. The EW systems may feature adaptive or dynamic scan scheduling mechanisms that can adjust scanning parameters based on real-time intelligence or operational feedback.

If the reported POI location indicates the presence of a high-priority emitter or signals of interest, the EW system may adaptively or dynamically adjust its scan schedule to allocate more resources (e.g., increased dwell time, specific scanning patterns) to further investigate or monitor that area. Conversely, if certain areas are consistently yielding negligible results, the system may redistribute resources by reducing scanning efforts in those regions. This dynamic adaptation of the scan schedule based on reported POI locations enables the EW system to optimize its performance, enhance situational awareness, and effectively respond to evolving threats or mission objectives in real-time.

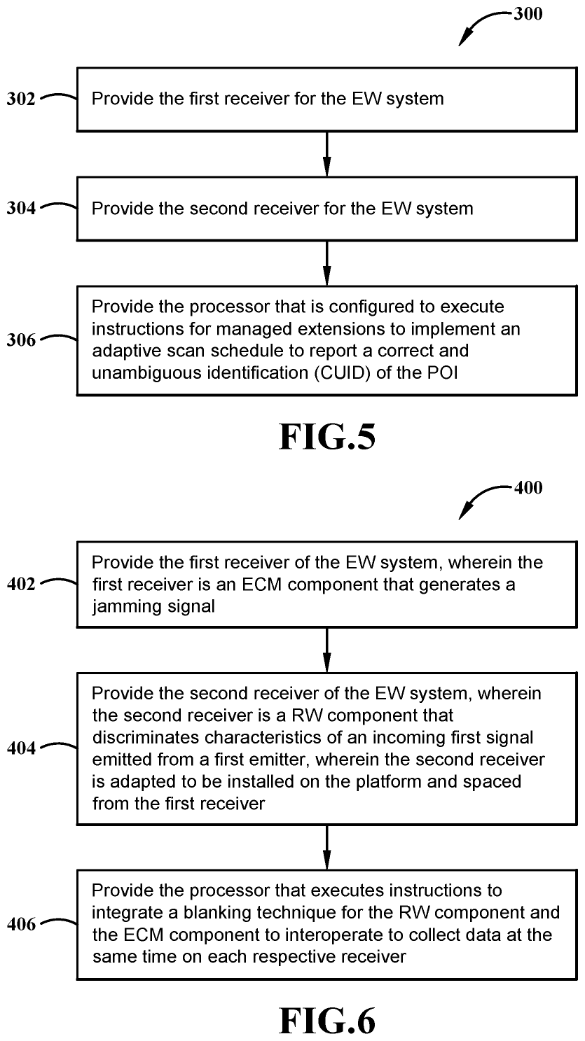

FIG. 5 depicts an exemplary method that may be implemented to effectuate adaptively adjusting the MDF and scan schedule (i.e., step 210). The method 300 may include providing the first receiver 20A for the EW system 10, which is shown generally at 302, wherein the first receiver has a first bandwidth at which the first receiver operates, and wherein the first receiver is configured to discriminate characteristics of an incoming first signal, the characteristics indicative of a source direction or geolocation of a first emitter producing the first signal, wherein the first receiver is adapted to be installed on the platform. Method 300 may also include providing the second receiver 20B for the EW system 10, wherein the second receiver has a second bandwidth at which the second receiver operates and the second bandwidth it different than the first bandwidth, and wherein the second receiver is configured to discriminate characteristics of an incoming second signal, the characteristics indicative of a source direction or geolocation of a second emitter producing the second signal, wherein the second receiver is adapted to be installed on the platform, and wherein one or both of the first emitter and the second emitter is a point of interest (POI), which is shown generally at 304. Method 300 may also include providing the processor 12 that is configured to execute instructions for managed extensions to implement an adaptive scan schedule to report a correct and unambiguous identification (CUID) of the POI, wherein the managed extensions include at least one of extensions for direction finding (DF), geolocation, polarization, gain, and pulse repetition interval (PRI) measurements for at least one of the incoming first and second signals, which is shown generally at 306.

The following examples and descriptions make reference to the receivers 20A, 20B as components of EW system 10. In one example, the components may be an electronic countermeasure (ECM) component (i.e., first receiver 20A) and a radar warning (RW) component (i.e., second receiver 20B).

One embodiment of the technique or algorithm utilizes a feedback mechanism to optimize how the system controls and manages an asset or resource to provide a result based on faster scans through the spectrum. There are several feedback mechanisms that could be implemented in the algorithm to optimize how the EW system 10 controls and manages a component, asset, or resource to provide a result based on faster scans through the spectrum. Some exemplary or possible types of feedback mechanisms that could be used in the algorithm are a Closed-Loop Feedback Control, a Predictive Feedback Control, or Reinforcement Learning, however other types of feedback mechanisms are entirely possible and the types described herein are exemplary.

Closed-Loop Feedback Control is an exemplary feedback mechanism that involves monitoring the output of the system and using that information to adjust the system's input. For example, if the EW system 10 is scanning through the spectrum too slowly, the closed-loop feedback control algorithm could detect this and increase the scanning speed accordingly. This feedback mechanism is continuous, precise, and allows the system to adapt quickly to changing conditions. To implement closed-loop feedback control, the EW system 10 may be equipped with sensors that measure the system's output. For example, in the case of the RW component, sensors could detect the frequency range of signals detected (i.e., one of the incoming signals from an emitter) and the time it takes to detect them. This information is then compared to the desired output, such as the frequency range the system should be scanning and the speed at which it should be detecting signals. Based on the comparison between the desired output and the actual output, the closed-loop feedback control algorithm would make adjustments to the system's input. For example, if the system is scanning too slowly, the algorithm could increase the scanning speed. This change in input would then be monitored to see if it results in the desired output. If the output is still not optimal, the algorithm would continue to adjust the input until the desired output is achieved. The closed-loop feedback control may be a useful feedback mechanism for the EW system 10 because it allows for continuous, precise adjustments to be made in real-time. This means that the system can quickly adapt to changing conditions and optimize its performance. Closed-loop feedback control is also robust and can handle variations in input and output, making it suitable for complex and dynamic environments. The closed-loop feedback control mechanism should be an effective way to optimize the performance of the EW system 10. By continuously monitoring the output of the system and adjusting the input, the system can quickly adapt to changing conditions and provide faster scans through the spectrum. This feedback mechanism is precise, continuous, and robust, making it suitable for use in complex and dynamic environments and works to maintain required performance against the highest priority threats.

Predictive Feedback Control is another exemplary feedback mechanism that involves predicting future system behavior based on current conditions and adjusting the input accordingly. For example, if the processor of EW system 10 detects or determines that it will need to scan a particular frequency range more frequently in the future, the predictive feedback control algorithm could allocate more resources to that frequency range in anticipation of the increased demand. This type of feedback mechanism allows the system to proactively manage resources, rather than reacting to changes as they occur. Also, this feedback mechanism is proactive, anticipatory, and allows the system to optimize its performance before any degradation occurs. To implement predictive feedback control, the EW system 10 would may be equipped with sensors that measure the system's output, as well as additional sensors that measure other relevant parameters, such as incoming signal parameters, weather conditions or user-specified objectives. For example, in the case of the ECM component, sensors could detect the frequency range of jamming signals and the amount of power being used to generate those signals. Other sensors could detect weather conditions that might affect the performance of the system, such as changes in temperature, clouds (water vapor), or atmospheric pressure. Based on the data collected from these sensors, the predictive feedback control algorithm would make adjustments to the system's input before any degradation in performance occurs. For example, if the sensors indicate that the incoming signal is becoming weaker due to changes in atmospheric conditions, the algorithm for the adaptive scan schedule could increase the power being used to generate the incoming signal to compensate for this degradation. This change in input would then be monitored to see if it results in the desired output. Predictive feedback control may be a useful feedback mechanism for the EW system 10 because it allows for proactive optimization of the system's performance. By anticipating changes in the system's output and making adjustments to the system's input before those changes occur, the system can avoid degradation in performance and provide faster scans through the spectrum. Predictive feedback control is also robust and can handle variations in input and output, making it suitable for complex and dynamic environments.

Reinforcement Learning is another exemplary feedback mechanism involves using a trial-and-error approach to learn the optimal way to allocate resources. The EW system 10 could be programmed to test different resource allocation strategies and measure their effectiveness over time. Based on this feedback, the system could adjust its resource allocation algorithm in adjusting the adaptive scan schedule to optimize performance. This type of feedback mechanism allows the system to learn and improve over time, even in complex and dynamic environments. The algorithm may then use this feedback to adjust its behavior, with the goal of maximizing the reward. To implement reinforcement learning in the EW system 10, the system may be designed to identify a specific goal or objective, such as maximizing the number of incoming signals detected or minimizing the time needed for scans. The reinforcement learning algorithm would may then take actions within the system to adjust the adaptive scan schedule to achieve this goal, while receiving feedback in the form of a reward or penalty. For example, in the case of the ECM component, the reinforcement learning algorithm could take actions to adjust the power and frequency range of the receiver or receive antenna to maximize the number of incoming signals detected by the RW component, while receiving feedback in the form of a reward or penalty based on the success or failure of the action. This feedback could be positive or negative, depending on whether the action resulted in an increase or decrease in the number of detected signals. Over time, the algorithm would learn from these actions and their outcomes, adjusting its behavior to maximize the reward or minimize the penalty. The reinforcement learning algorithm would also consider the trade-offs between different actions, balancing the potential reward against the potential penalty to determine the most optimal action to take. As the system learns from trial and error, it can adjust its behavior to optimize its performance in different scenarios. Reinforcement learning can also handle complex and nonlinear relationships between inputs and outputs, making it suitable for use in dynamic and uncertain environments.

Thus, implementing one or more of the exemplary feedback mechanisms in the algorithm allows the EW system 10 to optimize its performance in real-time by adjusting the adaptive scan schedule, thereby providing faster scans through the spectrum and more efficient use of resources. By continuously monitoring and adapting to changing conditions, the system can quickly respond to new threats and provide the necessary information to support mission objectives.

As the scan speed through the spectrum increases, the dwell time on each respective band decreases. The adaptive scan schedule of the present disclosure enables dwell times at frequency bands of interest to be extended so as to allow the receivers to obtain signal 30 from the LPI emitter. However, the adaptive scan schedule will shorten the dwell times on spectral bands that are of no interest to system 10. The adaptive scan schedule of the present disclosure enables system 10 to meet a response time even when complex modern LPI emitters are utilized to generate signal 30. The adaptive scan schedule of the present disclosure enables the scanning to occur quickly so as to enable system 10 to meet the operational parameters or operational time lines by optimizing or adaptively executing the scan schedules, the system 10 is able to scan faster, obtain a higher probability of intercept, obtain a better response time, and maintain the ability to identify exactly what LPI emitter is in the theater 32. Stated otherwise, the scan schedule of the present disclosure is cognitive and/or reactive to the environment of theater 32.

In one particular embodiment, the adaptive scan schedule or the additivity of the scan schedule may occur on a single receiver, such as first receiver 20A. However, most systems have multiple receivers. Accordingly, the system may have the capability to have multiple scan schedules or multiple adaptive scan schedules on multiple receivers, such as first receiver 20A and second receiver 20B. The multiple scan schedules algorithm determines how to control multiple scan schedules with multiple receivers or sensors that are each performing adaptive scan schedules. EW system 10 interweaves or interleaves multiple scan functions on each of those sensors or receivers. Thus, the EW system 10 of the present disclosure can coordinate the plurality of receivers to obtain an optimized total performance of the system. The EW system 10 enables the receivers, such as receivers 20A, 20B, to be utilized in a manner that is coordinated between them so as to produce an effective or optimal performance against the environment or theater 32. Complexity of the multiple scan schedules may occur when there are multiple functions operating on each of the receivers 20. However, the present disclosure address this complexity and overcomes the same. For example, each function has its own requirements for each receiver, and optimizing one function may come at the expense of another. For example, the ECM component may require the use of a particular receiver, while the RW component may need a different one. If both components need to operate simultaneously, then the system needs to allocate resources to ensure that each component can access the receiver it needs without interfering with the other. Furthermore, as the number of functions and receivers in the system increases, the complexity of the resource allocation problem increases. For example, if there are four functions and four receivers, there are 24 possible combinations of receivers that can be assigned to each function. In reality, not all of these combinations will be valid, and some may result in interference or other issues. The system should be able to quickly determine which combinations are valid and allocate the appropriate resources to each function. Another source of complexity arises from the fact that the optimal allocation of resources may change over time. For example, during an engagement, the ECM component may need to jam a particular signal, which could interfere with the RW component's ability to detect other signals. In this case, the system may need to re-allocate resources to ensure that the RW component can still function effectively. Ordinarily, the complexity of an EW system increases as the number of functions and receiver's increases, and as the system needs to dynamically allocate resources to ensure that each function can operate effectively without interfering with the others. Managing this complexity requires sophisticated algorithms and careful resource management to ensure that the system can adapt to changing conditions and provide the necessary performance.

One exemplary algorithm that can be used to manage the complexity and provide careful resource management for the multiple scan schedules on multiple assets in the EW system includes dynamic programming. Dynamic programming is an optimization technique that involves breaking down a problem into smaller subproblems and solving them iteratively. In the context of an EW system 10, this could involve breaking down the problem of resource allocation into smaller subproblems that can be solved more efficiently. For example, the system could first allocate resources to the most critical functions, and then allocate the remaining resources to the less critical functions. The algorithm could then continue to iterate, refining the allocation of resources until an optimal solution is found.

In the context of EW system 10, the dynamic programming algorithm for the use of multiple scan schedules may be a method that allows for the optimal allocation of resources, such as receivers, assets or components, to achieve a specific objective. In the context of the EW system 10, this algorithm or method may be used to determine the optimal scan schedule for each receiver, asset or component to minimize the blanking or look-through time, while also ensuring that the ECM component is not interfering with the RW component's ability to detect other signals. Look-through time refers to the duration during which the system's receivers or sensors are unable to detect or properly analyze incoming signals due to factors such as signal blanking, interference, or processing delays. Essentially, it represents the period where the system is “blind” to potential threats or targets. Thus, it is advantageous to minimize the look-through time.

In one exemplary embodiment, to apply the dynamic programming algorithm for multiple scan schedules, the EW system 10 may first define the problem as a set of states and actions. The states represent the current state of the system, which includes the current scan schedule for each receiver, asset or component, as well as the current noise level in each band. The actions represent the possible changes that can be made to the scan schedule, such as changing the scan frequency or duration. The dynamic programming algorithm may then create a table, known as the value function that calculates the expected reward for each state and action. The reward is a measure of how well the system is performing in achieving its objective, which is to minimize the blanking or look-through time or minimize response time. The value function may then be calculated iteratively, starting from the final state and working backward to the initial state.

For example, consider or assume that EW system 10 has three receivers, each operating in a different frequency band. The EW system 10 should try to minimize the blanking time while ensuring that the ECM component does not interfere with the RW component's ability to detect other signals. The initial scan schedule for each receiver may be set to a fixed frequency and duration. The dynamic programming algorithm can be used to find one or more of the optimal scan schedule(s) for each receiver that minimizes the blanking time. In the first iteration, the algorithm calculates the expected reward for each possible action, which is to change the scan frequency or duration for each receiver. The algorithm may then updates the value function for each state by selecting the action with the highest expected reward. This process may be repeated for each state until the value function converges to an optimal policy. In the second iteration, the algorithm may calculate the expected reward for each possible action, taking into account the current scan schedule for each receiver and the noise level in each band. The algorithm may then update the value function for each state by selecting the action with the highest expected reward. This process may be repeated until the value function converges to an optimal policy. For example, consider or assume that the algorithm determines that changing the scan frequency for the first receiver 20A and the second receiver 20B will result in the lowest blanking time. The algorithm then updates the scan schedule for the first receiver 20A and the second receiver 20B, while keeping the scan schedule for the third receiver constant. The algorithm may then repeat the process for the updated scan schedule until it converges to an optimal policy.

FIG. 6 depicts an exemplary method that may be implemented to effectuate interoperable components. Method 400 includes providing the first receiver 20A of the EW system 10, wherein the first receiver is an ECM component that generates a jamming signal, wherein the first receiver is adapted to be installed on the platform 22, which is shown generally at 402.

Method 400 includes providing the second receiver 20B of the EW system 10, wherein the second receiver is a RW component that discriminates characteristics of an incoming first signal emitted from a first emitter, wherein the second receiver is adapted to be installed on the platform and spaced from the first receiver, which is shown generally at 404. The spacing between the two receivers may depend on some exemplary factors, including the operational requirements, the frequency range of interest, the desired accuracy of direction finding or localization, and the characteristics of the signals being monitored. For example, the spacing between receivers should ideally be larger than the wavelength of the signals of interest. This ensures that the received signals at each receiver have distinguishable phase differences, which helps with direction finding and localization. Generally, larger spacing provides better resolution, allowing for more accurate determination of the angle of arrival or location of the signal source. However, this comes at the cost of increased complexity and potentially higher equipment costs. Proper spacing should attempt to minimize mutual interference between the antennas and ensures that each receiver can accurately capture the desired signals without significant contamination from neighboring sources. The specific mission requirements and operational environment play a role in determining the optimal spacing. The characteristics of the signals being monitored, such as their bandwidth, modulation scheme, and signal-to-noise ratio, can also influence the optimal spacing between receivers. For example, wider bandwidth signals may require larger spacing to ensure accurate direction finding or localization whereas narrower bandwidth signals may require smaller spacing.

Method 400 includes providing the processor 12 that executes instructions to integrate a blanking technique for the RW component and the ECM component to interoperate to collect data at the same time on each respective receiver, which is shown generally at 406.

This dynamic programming algorithm may be extended to multiple scan schedules across multiple receivers, assets or components. For example, the algorithm can be used to find the optimal scan schedule for each receiver on platform 22 or in a fleet of aircraft (or other platforms 22), where each platform 22 has multiple receivers operating in different frequency bands. The algorithm can also be used to find the optimal allocation of resources in a network of ground-based receivers, where each receiver is responsible for monitoring a different frequency band. Alternatively, the algorithm could start from the initial state and work forward to the final state, however this may be a less desirable method, albeit possible.

EW system 10 may need to operate in a very dense and complex environment. In this environment, there can be thousands or more RF signals operating in the environment at any given time, and the modern lethal emitters, such as LPI emitters, are operating in a fashion that reduces their probability of being detected by other receivers. EW system 10 should not only work within this extremely dense and complex environment, EW system 10 also needs to intercept (detect) these LPI emitters so as to inform the pilot and protect the platform. Receivers 20A, 20B and other receivers are inherently limited in their bandwidth (BW), Dynamic Range, Sensitivity, and other characteristics that restrict their ability to measure all emissions all the time. In order to overcome these limitations, receivers 20A, 20B and other receivers in system 10 scan over the different limitations to intercept all emitters. For example a receiver may be only capable of measuring half of the frequency spectrum at any instantaneous time. Therefore the receiver is switched between dwelling in two different frequency configurations to allow it to detect emissions at any required frequency. This sequencing of receiver configurations to achieve full spectral, spatial, and parametric coverage is referred to as a scan schedule. Any scanning by a receiver implies that the receiver will not have 100% probability of intercept (POI) on every emitter since it is no longer staring 100% of the time looking for each individual emitter. The optimization of a receivers scan schedule allow the user to achieve the highest Probability of Intercept (POI), within an acceptable Response Time (RT), and Detection Range, on all emitters based on the dynamic environment and adaptive mission priorities.

In addition to optimizing POI, a receiver must also optimize Probability of Detection (POD). POD is different from POI as every system has requirements to minimize false detections (noise, etc.), and allow for effective CUID. In order to achieve CUID, the EW system may require multiple measurements on an emitter. Prior systems had evolved algorithms to allow this POI/POD optimization to be made on a single receiver, but EW system 10 has multiple receivers 20A, 20B that are utilized in a fashion that optimizes the EW system's 10 POI/POD performance given all of the receiver assets available. A systems performance is no longer equivalent to the performance on one receiver, but rather the integrated performance of all of the receivers. The present disclosure provides techniques or algorithms that effectively distribute emitters and utilize multiple receivers, and multiple receiver types to effectively optimize the EW system's 10 POI/POD performance under any environmental conditions. These algorithms let the computer or logic of EW system 10 make the initial rules based emitter to receiver(s) allocations. The allocations are based on each receiver's capabilities relative to each emitters' capabilities and the systems response time requirements. Determining a system's ability to meet its response time requirement is based on the system's ability to achieve a high enough POI/POD performance at the designated Detection Range and within the allowable Response Time. These allocations can be overridden by an operator based on different mission specifics, but user overrides can lead to poorer performance. The algorithms also provide a prediction of performance based on all of the receiver assets and the environment the system is operating in.

With respect to interoperability between the receivers 20A, 20B allows for the transmitters to operate at the same time as receivers 20A, 20B. Normally, when transmitters transmit while receivers are attempting to receive a signal, the two functions will interact and disrupt each other. This is commonly known as interference. The interoperability of the assets integrates two previous federated systems into a single system.

In one exemplary embodiment, the algorithm or technique minimizes blanking or blanking time in a manner that the RW and ECM functions collect the necessary collections at the exactly the same time (on different receivers). These collections are controlled by the ECM function since the ECM function knows the signal is present (eliminating the RW Scan-On-Scan issue). The integrated look-through sequences allow for both RW and ECM to meet their collection needs while minimizing the total ECM blanking timeline. Through this integral approach, the necessary blanking percentage for the RW component is lowered to the point where the EW system 10 no longer has to be programmed for an allowable/permissible percentage into the MDFG. As a result, the RW component can maintain its track without having to dedicate any additional time to perform its look-throughs.

Integrating the ECM component (i.e., first receiver 20A) and the RW component (i.e., second receiver 20B) in EW system 10 results in a significant decrease in the look-through or blanking time required for the RW component because the ECM and RW components work together to mitigate the effects of the jamming signal. To prevent the RW component from detecting the jamming signal and reporting it as a signal of interest, the system must blank or ignore the signal for a certain period of time. This is known as the blanking period or look-through time. The ECM component can jam the signal while the RW component monitors the environment for new signals. However, if the RW component does not blank or look-through during the ECM's jamming, the jamming signal can appear to be another signal of interest, leading to false alarms or missed detections.

Several complex sequences or techniques can be employed to integrate the ECM component and RW component to reduce look-through time. One such technique is the use of adaptive filtering, which allows the EW system 10 to distinguish between the jamming signal and other signals of interest. Another technique is the use of frequency agility, which enables the EW system 10 to quickly switch between frequencies to avoid the jamming signal. Additionally, the EW system 10 can employ time division multiplexing to alternate between ECM and RW functions quickly.

In one embodiment of the present disclosure, adaptive filtering is a technique that can be used to integrate the ECM and RW components in an EW system 10 to reduce the look-through or blanking time required for the RW component. Adaptive filtering involves using algorithms to continuously monitor the signals received by the EW system 10 and adapt to changing environmental conditions, such as the presence of jamming signals.

Adaptive filtering can be implemented using various algorithms, such as the least mean squares (LMS) algorithm, recursive least squares (RLS) algorithm, or the Kalman filter, or combinations thereof. These algorithms work by adjusting the filter coefficients in real-time based on the input signal, allowing the EW system 10 to adapt to changes in the environment. Although these algorithms are exemplary, others are possible.

The LMS algorithm is an adaptive filtering algorithm that uses a stochastic gradient descent approach to minimize the difference between the filtered output signal and the desired signal. The algorithm works by adjusting the filter coefficients in the direction of the negative gradient of the error signal. The algorithm updates the filter coefficients at each time step based on the current input signal and the difference between the output signal and the desired signal.

The RLS algorithm is another popular adaptive filtering algorithm that uses a recursive approach to estimate the filter coefficients. The algorithm updates the estimate of the filter coefficients at each time step based on the current input signal and the error signal. The RLS algorithm has the advantage of being able to handle non-stationary signals, such as those that may be encountered in an EW system 10 environment.

The Kalman filter is a statistical algorithm that can be used to estimate the state of a dynamic system based on noisy measurements. The Kalman filter can be used to estimate the state of the signal and filter out the noise caused by the jamming signal. The filter works by estimating the state of the signal at each time step based on the previous state estimate and the current measurement.

Adaptive filtering allows the EW system 10 to distinguish between the jamming signal and other signals of interest. The EW system 10 can use the filter coefficients to adapt to changes in the environment and filter out the jamming signal, while still detecting other signals of interest. By integrating adaptive filtering with the ECM and RW components, the EW system 10 can reduce the look-through or blanking time required for the RW component, improving the system's ability to detect and respond to threats in real-time.

In another embodiment of the present disclosure, frequency agility enables the EW system 10 to quickly switch between frequencies to avoid the jamming signal. Frequency agility allows the EW system 10 to detect signals of interest by hopping between different frequencies, which reduces the likelihood of the jamming signal interfering with the EW system's 10 ability to detect other signals. The EW system 10 can use frequency-hopping techniques to quickly switch between different frequencies in response to the presence of a jamming signal.

In another embodiment, the EW system 10 can also employ time division multiplexing (TDM) to integrate the ECM and RW components in an EW system 10 to reduce the look-through or blanking time required for the RW component. TDM involves dividing the available time slots between different components of the EW system 10, such as the ECM and RW components, and allocating time slots to each component.

In TDM, the available time slots are divided into equal intervals, with each interval allocated to a different component of the EW system 10. During each interval, only the component allocated to that interval is allowed to transmit, while the other components remain silent. This allows the EW system 10 to use the same hardware for multiple functions, while still ensuring that each component has sufficient time to operate effectively.

To implement TDM in an EW system 10, the system can be configured to alternate between the ECM and RW modes at a high frequency, such as several times per second. During the ECM mode, the system transmits jamming signals, while during the RW mode, the system listens for signals of interest. The TDM technique allows the EW system 10 to switch between the two modes quickly, reducing the look-through or blanking time required for the RW component.

TDM may be a useful technique for integrating the ECM and RW components in an EW system 10 to reduce the look-through or blanking time required for the RW component. By allocating time slots to each component, the EW system 10 can use the same hardware for multiple functions, while still ensuring that each component has sufficient time to operate effectively. However, TDM may not be effective against complex or sophisticated jamming techniques, and may not be suitable for situations where multiple jammers are present.

In yet another embodiment, the EW system 10 can also employ complex waveform techniques to integrate the ECM and RW components in EW system 10 to reduce the look-through or blanking time required for the RW component. These techniques involve using complex waveforms, which are waveforms that have both amplitude and phase modulation, to encode the signal and reduce the impact of the jamming signal.

Complex waveform techniques work by modulating the signal in a way that makes it more resistant to jamming signals. This can be achieved by using techniques such as frequency hopping, direct sequence spread spectrum, or chirp modulation. Frequency hopping involves rapidly switching the carrier frequency of the signal, while direct sequence spread spectrum involves spreading the signal over a wide frequency band. Chirp modulation involves modulating the frequency of the signal over time.

One exemplary advantage of complex waveform techniques is that they are resistant to jamming signals that have a narrowband frequency spectrum. The complex modulation techniques can spread the signal across a wider frequency band, making it more difficult for the jamming signal to interfere with the signal of interest.

To implement complex waveform techniques in EW system 10, the system can be configured to use a variety of modulation techniques, depending on the specific requirements of the mission. The EW system 10 can be designed to switch between different modulation techniques in response to changing environmental conditions, such as the presence of jamming signals.

These exemplary techniques, amongst other technique that can be performed, enable the EW system 10 to quickly and accurately distinguish between the jamming signal and other signals of interest, reducing the look-through or blanking time required for the RW component. By integrating the ECM and RW components using these or other techniques, the EW system 10 can improve its ability to detect and respond to threats in real-time, increasing its overall efficiency and effectiveness.

In another embodiment of the present disclosure and with respect to the optimization of multiple scan schedules, there may be joint MDFG optimization thereof. In a multiple receivers system, EW system 10, generates multiple planned scan schedule sets (multiple scan schedules for each receiver), that are interleaved throughout the mission, based on the receiver assets that are available at any given time during a mission for the RW and/or ECM. These different scan schedule sets provide the aircrew with a predictable system performance that is optimized for the current environmental load and receiver allocation. This allocation of receiver assets may be managed in real-time and based on the efficient integration of all available assets at any moment during a mission.

In one exemplary embodiment, EW system 10 integrates the RW and ECM components such that both components now have access to all of the assets in the system (e.g., the receivers). In order to integrate these two components, the EW system 10 includes techniques or algorithms to allow sharing of resources between the components. This requires that each receiver be configured in a way to meet the needs of both RW and ECM collections. In one embodiment, the EW system 10 manages the receiver assets in real-time such that RW and ECM performance is optimized for any environmental condition. This integrated approach allows for dynamic allocation of receivers to the two components as the environmental conditions or mission priorities change. Resource management may be necessary for the system's 10 adaptive response in order to maintain integrated performance of both components. By integrating the RW component and the ECM components, the EW system 10 is able to make dynamic resource allocations in a few microseconds or a few nanoseconds as the environmental situation evolves.

In one example, EW system 10 is comprised of multiple receivers that have different performance metrics. In one example, there is a first performance metric of the first receiver and a second performance metric of the second receiver, wherein the first performance metric and the second performance metric are different. The first performance metric may be POI/RT performance and the second performance metric may be CUID performance. However, it possible to utilize two other performance metrics. The technique or algorithm determines the optimal way to allocate the receiver resources to optimize total system performance. This allows the different receivers to work together in order to intercept different signals. The receiver allocation technique or algorithm allows the system to distribute emitters automatically to multiple receivers with different capabilities as the receivers become available. This multi-receiver allocation allows the system to optimally distribute the required receiver loading and achieve the best possible cumulative response time for all of the specified modern emitters.

Integrating the ECM and RW components may cause the necessary blanking percentage for the RW component to be so low that the EW system 10 no longer has to program that blanking percentage into the MDFG. This is because the ECM and RW components work together to mitigate the effects of the jamming signal, and the EW system 10 can quickly switch between ECM and RW functions, reducing the need for dedicated blanking periods. Namely, when the ECM component is jamming the signal, it creates noise that can interfere with the RW component's ability to detect other signals. Integrating the ECM and RW components can reduce the necessary blanking period in several ways. For example, using the above-referenced complex waveform techniques or adaptive filtering can help the RW component filter out the noise created by the jamming signal, allowing it to detect other signals more quickly. Similarly, using time division multiplexing can allow the EW system 10 to switch quickly between the ECM and RW modes, reducing the amount of time the system needs to blank the signal. By reducing the necessary blanking period, the EW system 10 can respond much more quickly and efficiently to signals of interest, improving the system's overall performance. Additionally, by integrating the ECM and RW components, the system can use the same hardware for multiple functions, reducing the complexity and cost of the system. Integrating the ECM and RW components can significantly reduce the necessary blanking percentage for the RW component, to the point where the EW system 10 no longer needs to program that blanking percentage into the MDFG. This can improve the system's performance, reduce the complexity and cost of the system, and enhance the system's ability to detect and respond to threats in real-time.

Furthermore, the RW component can respond much more quickly and efficiently without having to dedicate a large amount of time to look-through time because the integration of the ECM and RW components enables the EW system 10 to quickly and accurately distinguish between the jamming signal and other signals of interest. This improves the EW system's ability to detect and respond to threats in real-time, increasing its overall efficiency and effectiveness.

In an integrated EW system 10, resource management may be important for maintaining integrated performance. The system of the present disclosure is able to adapt dynamically to the changing environment and the user's mission requirements so as to provide joint MDFG optimization of multiple scan schedules, and allocate resources in real-time to ensure optimal performance. To achieve this, the EW system 10 needs to implement user-adaptive algorithms that can be optimized based on the user's mission.

One such algorithm is the user-specific scan schedule optimization algorithm, which optimizes the scan schedule based on the user's mission requirements. The algorithm takes into account the frequency bands, the location of assets, and the priority of signals, and dynamically allocates resources to the RW and ECM components (i.e., first receiver 20A and second receiver 20B) based on the mission's needs.

Another algorithm that can be used is the dynamic resource allocation algorithm, which allows the EW system 10 to allocate resources dynamically as the situation changes. This algorithm monitors the system's performance and adapts to changes in the environment, such as the appearance of new signals or the interference caused by the ECM component. The algorithm allocates resources based on the current situation, allowing the system to respond quickly and efficiently to threats.

The EW system 10 also needs to implement an algorithm that allows for dynamic allocation of receivers as the situation changes. This algorithm allocates resources to the RW and ECM components based on the user's mission requirements and the current situation, allowing the system to use the receivers efficiently and adapt to changes in the environment.

To achieve user adaptation, the EW system 10 also needs to implement an algorithm that optimizes the ECM's power and frequency allocation based on the user's mission requirements. This algorithm takes into account the frequency bands, the location of assets, and the priority of signals and dynamically allocates the ECM's power and frequency resources based on the mission's needs. This algorithm ensures that the ECM component does not interfere with the detection of signals of interest, while still effectively jamming the system's own signals.

The EW system 10 should implement an algorithm that enables it to detect and adapt to changes in the environment, such as new threats, emitter density, or changes in the electromagnetic spectrum. This algorithm monitors the environment and adapts the system's parameters, such as the frequency bands and the power allocation, based on the changes. The algorithm ensures that the system maintains optimal performance, even as the environment changes.

Thus, integrating the RW component and the ECM component in EW system 10 allows for dynamic allocation of resources and an adaptive response that maintains optimal integrated performance. By implementing user-adaptive algorithms, the system can optimize its performance based on the user's mission requirements and dynamically rapidly allocate resources in nanoseconds as the situation changes. These algorithms, as well as other possible algorithms, enable the EW system 10 to efficiently use its resources, adapt to changes in the environment, and respond quickly and efficiently to threats, leading to an overall improvement in the EW system's 10 performance.

Although the aforementioned examples have made reference to the RW component and the ECM component as the first receiver 20A and the second receiver 20B of the EW system 10, it is to be understood that these two receivers are merely exemplary and other components of the EW system 10 could be integrated together in the manner taught herein.

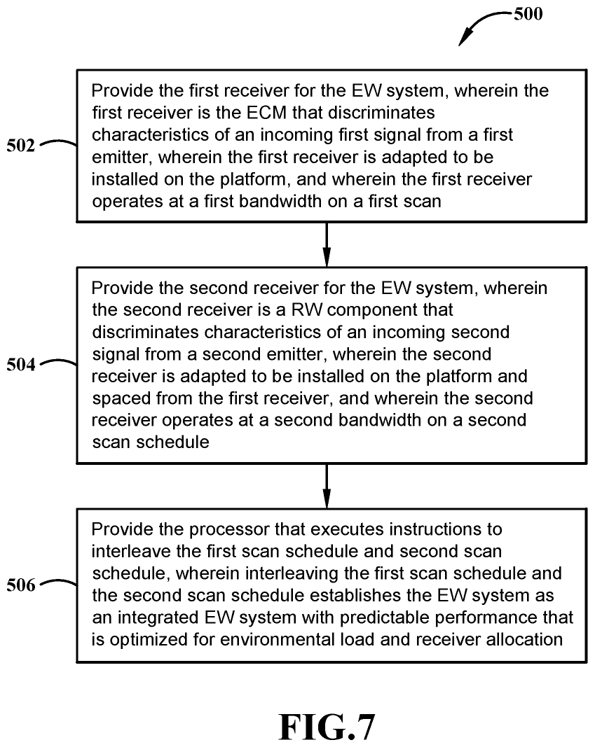

FIG. 7 depicts an exemplary method for the integrated or interleaved EW system with predictable performance that is optimized for environmental load and receiver allocation. Method 500 includes providing the first receiver 20A for the EW system 10, wherein the first receiver is the ECM that discriminates characteristics of an incoming first signal from a first emitter, wherein the first receiver is adapted to be installed on the platform, and wherein the first receiver operates at a first bandwidth on a first scan schedule, which is shown generally at 502. Method 500 includes providing the second receiver 20B for the EW system 10, wherein the second receiver is a RW component that discriminates characteristics of an incoming second signal from a second emitter, wherein the second receiver is adapted to be installed on the platform and spaced from the first receiver, and wherein the second receiver operates at a second bandwidth on a second scan schedule, which is shown generally at 504. Method 500 includes providing the processor 12 that executes instructions to interleave the first scan schedule and second scan schedule, wherein interleaving the first scan schedule and the second scan schedule establishes the EW system as an integrated EW system with predictable performance that is optimized for environmental load and receiver allocation, which is shown generally at 506.

Actions taken to accomplish mission objectives in response to detected changes in the environment may vary, depending on the specific changes detected, as well as based on the original mission objectives. For example, if the original mission objective was to observe an emitter target, and that target is no longer online or present in theater 32, the mission objective may change to, for example, jamming a different emitter. It will therefore be understood that the specific actions undertaken in these processes are dictated on a case-by-case basis, and may change in any given scenario. The examples provided herein are non-exhaustive of the possible actions undertaken in response to the changing environment, and are thus non-limiting thereof.

It will be further understood that actions taken in response to detected changes in the environment are not limited to pilot action or decision. Instead, some responsive actions may be automatically triggered and/or deployed. By way of one non-limiting example, if an observed change in the environment is an extreme threat, such as an incoming missile, OFP may deploy countermeasures such as chaff and/or flares, and may automatically direct aircraft 24 to take evasive actions without input from the pilot thereof.

Some of these method steps may be automated in that they may be automatically performed based on pre-determined criteria. One example of such a criterion may include the completion of a prior step in the associated process. Another example may be the detection of a previously undetected emitter, which may trigger one or more steps of process 100 and/or process 200 to occur.

According to one aspect, process 200 may be fully automated in that it does not require any manual input from pilot of aircraft 24 until the process is complete. According to this aspect, pilot may only be notified of any changes to the MDF, the scan schedule, or any other aspect of the mission if and/or when pilot interaction is required while automatically performing process 200 otherwise.

The system 10 of the present disclosure may additionally include one or more sensor to sense or gather data pertaining to the surrounding environment or operation of the system 10. Some exemplary sensors capable of being electronically coupled with the system 10 of the present disclosure (either directly connected to the system 10 of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure. The program may reside on an FPGA and its instructions may be firmware based.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An electronic warfare (EW) system, the EW system comprising:
a first receiver, wherein the first receiver is an electronic countermeasure (ECM) component to discriminate characteristics of an incoming first signal from a first emitter, wherein the first receiver is adapted to be installed on a platform, and wherein the first receiver operates at a first bandwidth on a first scan schedule;
a second receiver, wherein the second receiver is a radar warning (RW) component to discriminate characteristics of an incoming second signal from a second emitter, wherein the second receiver is adapted to be installed on the platform and spaced from the first receiver, and wherein the second receiver operates at a second bandwidth on a second scan schedule; and
a processor that executes instructions to interleave the first scan schedule and second scan schedule, wherein the interleaving of the first scan schedule and the second scan schedule is optimized for environmental load and receiver allocation.

2. The EW system of claim 1, wherein the instructions control assets of the first receiver and the second receiver to be dynamically allocated in real time, where the assets comprise one or more processors, frequency converters, transceiver, and antennas.

3. The EW system of claim 1, wherein the instructions control assets of the first receiver and the second receiver to be allocated in real time based on integration of all available asset at any time during operation of the EW system.

4. The EW system of claim 1, wherein the instructions integrate assets of the first receiver and the second receiver to be shared between the first receiver and the second receiver.

5. The EW system of claim 1, wherein the instructions integrate assets of the first receiver and the second receiver to be shared amongst all receivers in the EW system.

6. The EW system of claim 1, further comprising:
a first performance metric of the first receiver;
a second performance metric of the second receiver, wherein the first performance metric and the second performance metric are different.

7. The EW system of claim 1, further comprising:
a joint mission data file generator (MDFG) communicatively coupled with both the first receiver and the second receiver, wherein the joint MDFG optimizes the first scan schedule and second scan schedule based on a blanking percentage of one of the ECM component and the RW component.

8. The EW system of claim 7, wherein a user-specific scan schedule optimization algorithm considers frequency, receiver location, and priority of the incoming first and second signals when optimizing the first scan schedule and second scan schedule based on the blanking percentage of one of the ECM component and the RW component.

9. The EW system of claim 7, wherein the joint MDFG is in operative communication with a user-specific scan schedule optimization algorithm that optimizes the first scan schedule and the second scan schedule dynamically in response to environmental changes.

10. The EW system of claim 9, wherein the user-specific scan schedule optimization algorithm takes into account a new incoming signal and signal interference.

11. A method comprising:
providing a first receiver for an electronic warfare (EW) system, wherein the first receiver is an electronic countermeasure (ECM) that discriminates characteristics of an incoming first signal from a first emitter, wherein the first receiver is adapted to be installed on the platform, and wherein the first receiver operates at a first bandwidth on a first scan schedule;
providing a second receiver for the EW system, wherein the second receiver is a radar warning (RW) component that discriminates characteristics of an incoming second signal from a second emitter, wherein the second receiver is adapted to be installed on the platform and spaced from the first receiver, and wherein the second receiver operates at a second bandwidth on a second scan schedule; and
providing a processor that executes instructions to interleave the first scan schedule and second scan schedule, wherein interleaving the first scan schedule and the second scan schedule is optimized for environmental load and receiver allocation.

12. The method of claim 11, further comprising:
effecting the instructions to dynamically allocate assets of the first receiver and the second receiver in real time based on integration of all available asset at any time during operation of the EW system.

13. The method of claim 11, further comprising:
effecting the instructions integrate assets of the first receiver and the second receiver to be dynamically shared between the first receiver and the second receiver.

14. The method of claim 11, further comprising:
providing a joint mission data file generator (MDFG) communicatively coupled with both the first receiver and the second receiver; and
effecting the joint MDFG to optimize the first scan schedule and second scan schedule based on a blanking percentage of one of the ECM component and the RW component.

15. The method of claim 14, wherein the joint MDFG is in operative communication with a user-specific scan schedule optimization algorithm that optimizes the first scan schedule and the second scan schedule dynamically in response to mission requirements.

16. The method of claim 15, wherein the user-specific scan schedule optimization algorithm accounts for frequency, receiver location, and priority of the incoming first and second signals.

17. The method of claim 14, wherein the joint MDFG is in operative communication with a user-specific scan schedule optimization algorithm that optimizes the first scan schedule and the second scan schedule dynamically in response to environmental changes.

18. The method of claim 17, wherein the user-specific scan schedule optimization algorithm takes into account a new incoming signal and signal interference.
